(19) United States
(12) Patent Application Publication
(10) Pub. No.: US 2021/0370949 A1
(43) Pub. Date: Dec. 2, 2021

(54) Automobile Biometric Sensor Assembly

(71) Applicant: Cathy Williams, Indianapolis, IN (US)

(72) Inventor: Cathy Williams, Indianapolis, IN (US)

(21) Appl. No.: 16/889,960

(22) Filed: Jun. 2, 2020

(51) Int. Cl. B60W 40/08; B62D 1/06; B60W 50/14; B60N 2/00; H04Q 9/00

(52) U.S. Cl. CPC B60W 40/08; B62D 1/06; B60W 50/14; H04Q 2213/002; H04Q 9/00; B60W 2540/221; B60N 2/002

(57) ABSTRACT

An automobile biometric sensor assembly for monitoring biometric parameters of a person driving a vehicle includes a display that is positioned within a vehicle and that displays indicia comprising biometric values of a person. A plurality of seat sensors is each embedded in a seat in a vehicle. Each of the sensors senses biometric parameters of the person in the seat when the person sits in the seat and each of the seat sensors is in communication with the display. A plurality of steering wheel sensors is each embedded into a steering wheel to be in physical contact with the person when the person grips the steering wheel. Moreover, each of the steering wheel sensors senses biometric parameters of the person and each of the steering wheel sensors is in communication with the display.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sensor devices and more particularly pertains to a new sensor device for monitoring biometric parameters of a person driving a vehicle.

### (2) Description of Related Art Including Information Disclosed Under 37 CFR 1.97 and 1.98

The prior art relates to sensor devices. The prior art discloses a variety of biometric sensing devices that is integrated into the steering wheel of a vehicle. In each case the biometric sensing devices have novel structure with respect to each other. The prior art discloses a diagnostic device that is integrated into a vehicle for analyzing biometric parameters of the person in combination with a questionnaire for determining a diagnosis for the person.

### (h) Brief Summary of the Invention

An embodiment of the disclosure meets the needs presented above by generally comprising a display that is positioned within a vehicle and that displays indicia comprising biometric values of a person. A plurality of seat sensors is each embedded in a seat in a vehicle. Each of the sensors senses biometric parameters of the person in the seat when the person sits in the seat and each of the seat sensors is in communication with the display. A plurality of steering wheel sensors is each embedded into a steering wheel to be in physical contact with the person when the person grips the steering wheel. Moreover, each of the steering wheel sensors senses biometric parameters of the person and each of the steering wheel sensors is in communication with the display.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a phantom in-use view of an automobile biometric sensor assembly according to an embodiment of the disclosure.

FIG. 2 is a perspective view of a seat and a plurality of seat sensors of an embodiment of the disclosure.

FIG. 3 is a perspective view of a steering wheel and a plurality of steering wheel sensors of an embodiment of the disclosure.

FIG. 4 is a schematic view of an embodiment of the disclosure.

### DETAILED DESCRIPTION OF THE INVENTION

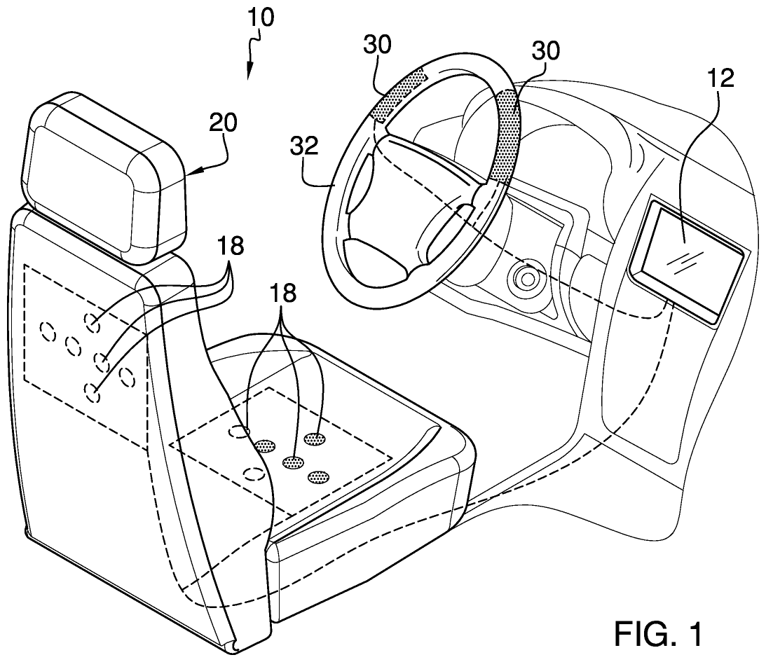

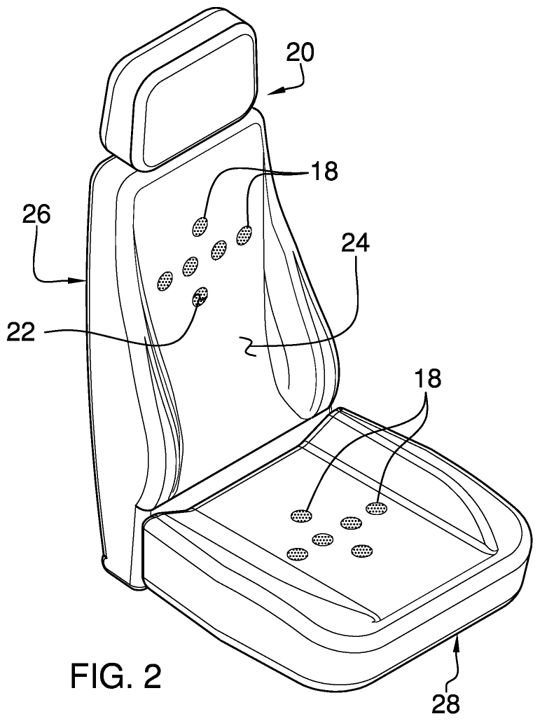

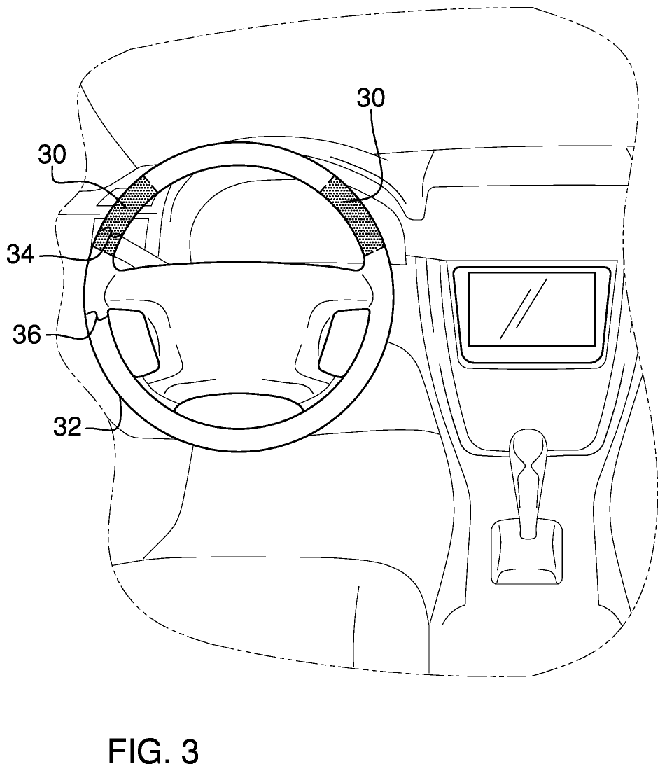

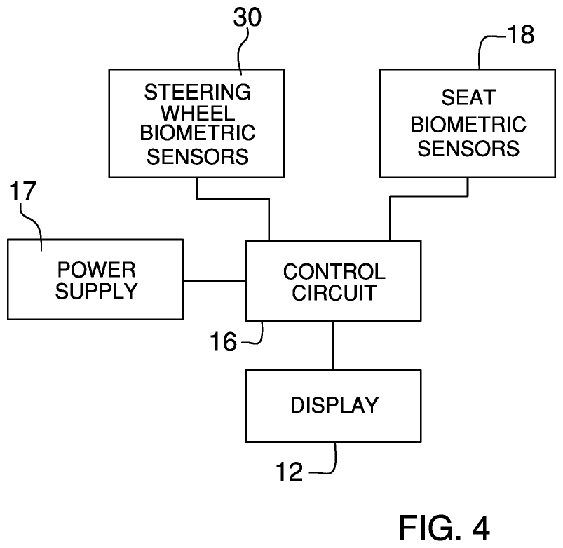

With reference now to the drawings, and in particular to FIGS. 1 through 4 thereof, a new sensor device embodying the principles and concepts of an embodiment of the disclosure and generally designated by the reference numeral 10 will be described.

As best illustrated in FIGS. 1 through 4, the automobile biometric sensor assembly 10 generally comprises a display 12 that is positioned within a vehicle. The display 12 displays indicia 14 comprising biometric values of a person, including but not being limited to, blood pressure, pulse rate and blood oxygen levels. The display 12 may be a display on an existing radio in the vehicle or the display 12 may be an aftermarket add on. The vehicle may be a passenger vehicle, a cargo vehicle, a public transport vehicle or any other motorized vehicle that is driven on public roadways. Additionally, the vehicle may be a fleet vehicle that requires drivers of the vehicle to get regularly scheduled physical examinations for driving certification. A control circuit 16 is integrated into the display 12, the display 12 is in electrical communication with the control circuit 16 and the control circuit is in electrical communication with a power supply 17 comprising an electrical system of the vehicle.

A plurality of seat sensors 18 is each embedded in a seat 20 in a vehicle such that each of the seat sensors 18 is in physical contact with a person sitting in the seat 20. Each of the seat sensors 18 senses biometric parameters of the person in the seat 20 when the person sits in the seat 20. Each of the seat sensors 18 has a sensing surface 22 and the sensing surface 22 of each of the plurality of seat sensors 18 is aligned with an outer surface 24 of the seat 20. Moreover, the plurality of seat sensors 18 are spaced apart from each other and are distributed over a back rest 26 and a seat portion 28 of the seat 20. Each of the seat sensors 18 is electrically coupled to the control circuit 16 for displaying the biometric parameters sensed by the seat sensors 18. Additionally, each of the seat sensors 18 may comprise an electronic biometric sensor that is at least capable of sensing blood pressure and pulse rate.

A plurality of steering wheel sensors 30 is provided and each of the steering wheel sensors 30 is embedded into a steering wheel 32 in the vehicle. In this way each of the steering wheel sensors 30 is in physical contact with the person when the person grips the steering wheel 32. Each of the steering wheel sensors 30 senses biometric parameters of the person when the person grips the steering wheel 32. Each of the steering wheel sensors 30 has a sensing surface 34 and the sensing surface 34 of each of the steering wheel sensors 30 is aligned with an outer surface 36 of the steering wheel 32.

Each of the steering wheel sensors 30 is positioned approximately at a respective ten o'clock position or a two o'clock position on the steering wheel 32. In this way each of the steering wheel sensors 30 is likely to be in contact with the person's hands while the person is gripping the steering wheel 32. Each of the steering wheel sensors 30 is electrically coupled to the control circuit 16 such that the display 12 can display the biometric parameters sensed by the steering wheel sensors 30. Moreover, each of the steering wheel sensors 30 may comprise an electronic biometric sensor that is at least capable of sensing blood pressure and pulse rate.

In use, each of the seat sensors 18 senses the biometric parameters of the person when the person sits in the seat 20 and each of the steering wheel sensors 30 senses the biometric parameters of the person when the person grips the steering wheel 32. The display 12 displays the biometric parameters while the person is driving the vehicle. In this way the person can monitor their biometric parameters while the person is driving. Thus, the person can conscientiously relax, breathe deeply and otherwise calm themselves down when the person is displaying elevated biometric parameters. In this way the person can be prepared to pass a physical examination if the person is a commercial driver that is subject to regularly scheduled physical examinations.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automobile biometric sensor assembly being configured to be mounted in a vehicle thereby facilitating biometric values of a driver to be recorded, said assembly comprising:
a display being positioned within a vehicle, said display displaying indicia comprising biometric values of a person;
a plurality of seat sensors, each of said seat sensors being embedded in a seat in a vehicle wherein each of said seat sensors is configured to be in physical contact with a person sitting in said seat, each of said sensors sensing biometric parameters of the person in said seat when the person sits in said seat, each of said seat sensors being in communication with said display; and
a plurality of steering wheel sensors, each of said steering wheel sensors being embedded into a steering wheel wherein each of said steering wheel sensors is configured to be in physical contact with the person when the person grips said steering wheel, each of said steering wheel sensors sensing biometric parameters of the person, each of said steering wheel sensors being in communication with said display.

2. The assembly according to claim 1, further comprising a control circuit being integrated into said display, said display being in electrical communication with said control circuit.

3. The assembly according to claim 1, wherein each of said sensors has a sensing surface, said sensing surface of each of said plurality of sensors being aligned with an outer surface of said seat, said plurality of sensors being spaced apart from each other and being distributed over a back rest and a seat portion of said seat.

4. The assembly according to claim 2, wherein each of said seat sensors is electrically coupled to said control circuit wherein said display is configured to display the biometric parameters sensed by said seat sensors.

5. The assembly according to claim 1, wherein each of said steering wheel sensors has a sensing surface, said sensing surface of each of said steering wheel sensors being aligned with an outer surface of said steering wheel.

6. The assembly according to claim 5, wherein each of said steering wheel sensors is positioned approximately at a respective ten o'clock position or a two o'clock position on said steering wheel.

7. The assembly according to claim 2, wherein each of said steering wheel sensors being electrically coupled to said control circuit wherein said display is configured to display the biometric parameters sensed by said steering wheel sensors.

8. An automobile biometric sensor assembly being configured to be mounted in a vehicle thereby facilitating biometric values of a driver to be recorded, said assembly comprising:
a display being positioned within a vehicle, said display displaying indicia comprising biometric values of a person;
a control circuit being integrated into said display, said display being in electrical communication with said control circuit;
a plurality of seat sensors, each of said seat sensors being embedded in a seat in a vehicle wherein each of said seat sensors is configured to be in physical contact with a person sitting in said seat, each of said sensors sensing biometric parameters of the person in said seat when the person sits in said seat, each of said sensors having a sensing surface, said sensing surface of each of said plurality of sensors being aligned with an outer surface of said seat, said plurality of sensors being spaced apart from each other and being distributed over a back rest and a seat portion of said seat, each of said seat sensors being electrically coupled to said control circuit wherein said display is configured to display the biometric parameters sensed by said seat sensors; and
a plurality of steering wheel sensors, each of said steering wheel sensors being embedded into a steering wheel wherein each of said steering wheel sensors is configured to be in physical contact with the person when the person grips said steering wheel, each of said steering wheel sensors sensing biometric parameters of the person, each of said steering wheel sensors having a sensing surface, said sensing surface of each of said steering wheel sensors being aligned with an outer surface of said steering wheel, each of said steering wheel sensors being positioned approximately at a respective ten o'clock position or a two o'clock position on said steering wheel, each of said steering wheel sensors being electrically coupled to said control circuit wherein said display is configured to display the biometric parameters sensed by said steering wheel sensors.
